(19) United States
(12) Patent Application Publication
(10) Pub. No.: US 2018/0174177 A1
(43) Pub. Date: Jun. 21, 2018

(54) ADVERTISING METHOD WITH USER DATA ACCOUNT INCENTIVES

(71) Applicant: 101294542 Saskatchewan Ltd., Saskatoon (CA)

(72) Inventors: Joseph DONLEVY, Saskatoon (CA); David CALLELE, Saskatoon (CA)

(21) Appl. No.: 15/668,556

(22) Filed: Aug. 3, 2017

(30) Foreign Application Priority Data
Dec. 15, 2016 (CA) 2951685

(51) Int. Cl. G06Q 30/02; G06F 3/0482; G06F 17/30

(52) U.S. Cl. CPC G06Q 30/0218; G06Q 30/0244; G06F 17/30; G06Q 30/0269; G06F 3/0482

(57) ABSTRACT

A method of advertising where a user is compensated for viewing of an advertisement on a user device by application of an earned credit to a target data account of the user. In initiating an advertising session from a user device a user provides the identification details of a target data account, and receives a display of a selected advertisement of an advertiser to the user device. Following completion of the display of the advertisement at least one earned credit is applied to the target data account. An advertising session can be initiated by a user or by a network device. An advertising server operatively connected to a network for the facilitation of the method is also disclosed.

### PRIORITY CLAIM

The present application claims priority to Canadian Patent Application No. 2951685, filed on Dec. 15, 2016, which said application is incorporated by reference in its entirety herein.

### FIELD OF THE INVENTION

This invention is in the field of electronic advertising methods.

### BACKGROUND OF THE INVENTION

Worldwide advertising expenditures are estimated to be greater than $500 Billion USD per year. Unfortunately, it is very challenging to measure advertising effectiveness—for example, to determine whether the advertiser's message is delivered to the correct target audience, whether the advertising message is understood by the viewer and whether the advertising message affects the viewer's behavior in the desired manner. Traditional tools like surveys and focus groups fail to keep up with on-demand and internet based efforts and much prior art has focused on means to engage with and gather feedback from individuals on a real-time or near real-time basis.

Traditional advertising delivery channels and methods are of diminishing importance as fewer people rely heavily on printed publication, traditional television or radio during their day to day lives. Increasing reliance on smartphones, computers, tablets and other data-based devices have changed the optimal advertising delivery methods, particularly where demographic audiences most highly adopting these new technologies such as millennials and young consumers are concerned.

Advertising methods in which delivery of advertising content to data network connected devices is achieved are becoming more prevalent. One of the changes in this type of advertising delivery is that these ads delivered to individual devices are more of a “one to one” experience, versus the “one to many” approach of broadcast media advertising. Engaging a user of a device in such a one to one session most often requires an opt in from the user to provide maximized engagement of the user/viewer with the content provided. Methods of maximizing user engagement in the acceptance or initiation and receipt of such advertising material are important as the business evolves.

The advertising industry has attempted to improve viewer engagement with increasingly elaborate advertisements with a particular emphasis on video delivery. Unfortunately, elaborate advertisements can be expensive to deliver, consuming significant network capacity, and when viewers function within a billing regime where capacity consumption is limited there is a significant economic dis-incentive to permit reception of these advertisements. These conflicting constraints have led to the rise of advertisement blocking technologies that impede advertising effectiveness, degrade the user experience and have significant negative economic impact upon the websites hosting the advertisements due to their inability to generate revenue from delivering the advertisements.

Given the prevalence of tablets, smartphones and other portable data network connected devices, advertising methods that accommodate or encourage participation in qualified advertising sessions via such a device would be positively received.

One of the limitation of wireless and other data network connected devices is the costs associated with network bandwidth. Many consumers have data accounts on the networks of certain data network providers capped in their throughput either in speed, quality or volume. Many consumers also pay for higher quality network access on their user devices, but such network access typically comes at a cost higher than regular consumption. Consuming the paid bandwidth available to a user on their data account to stream advertising content to their user device—particularly if the advertising content was not specifically requested—can alienate the consumer and cause them to be disinclined to favorably view same.

If it were possible to deliver advertising content to the user devices of users in a way that the user would be compensated for the data services consumed in their receipt and viewing of same would be a novel approach to enhancing user engagement with such material on delivery.

Efforts in the prior art have addressed payment or compensation to viewers for watching and interacting with advertisements with many mechanisms such as points rewards, discount coupons and micropayments. These viewer compensation mechanisms have had varying degrees of success. A method of advertising content delivery to network devices in which the user viewing the content would be compensated for viewing or interacting with the advertisement by earning service credits to selected data accounts would allow for cost neutrality to the consumer, and these advertising viewers could be considered reasonably highly qualified leads for these advertisers.

### SUMMARY OF THE INVENTION

The invention comprises a method of advertising where a user is compensated for viewing of a selected advertisement on a user device by application of an earned credit to a target data account of the user on completion of the advertising session. By offering a credit to a data account, an advertiser can provide some compensation to the viewer both for the time and the financial cost of data network consumption in the viewing of advertisements, and the method will provide for an enhanced interactivity with users viewing advertisements.

Different earned credits to be provided to the target data account might be selected from at least:
Extending the capacity limit of the target data account by at least the network capacity required to view the advertisement;
Crediting the capacity limit of the target data account by at least the network capacity required to view the advertisement;
Not charging the capacity limit of the target data account by at least the network capacity required to view the selected advertisement;
Enhancing the network speed provided to user devices using the target data account;
Providing enhanced quality of service to user devices using the target data account;
Providing access to exclusive network content to user devices using the target data account;
Goods or services of the data network provider of the target data account or a selected advertiser or third-party.

Any number of different earned credits will be understood to be within the scope of the present invention.

The first step of the method is to allow a user, using a user device, to initiate an advertising session. The session can be manually initiated, or can be initiated by a user from a user device in communication with a network device. Multiple approaches to manual user initiation of an advertising session, or to the automated or technology assisted initiation of an advertising session from one of several network access points are outlined herein.

A user with a user device could manually initiate an advertising session by manually accessing a system in which the steps of the method could be undertaken, or in other cases an advertising engine software component in communication with the user device of the user on a network could automatically initiate the advertising session. Many types of manually or systemically actuated initiating steps of the method of the present invention will be understood to those skilled in the art of the design of such systems and all such approaches are contemplated within the scope of the present invention.

An advertising session can be initiated by a prompt to the user of a user device triggered by a data network provider—for example the data network provider to a user device on a data network might automatically initiate a prompt to prompt whether it was desired to participate in an advertising session if it was detected that the user was approaching a data limit point on the data account associated with their device. The prompt might comprise an electronic message delivered to the user interface of the user device. It is explicitly contemplated that the user device used to participate in an advertising session might be a wireless device connected to a wireless network, and the target data account of the user is the wireless network account of the user device on the wireless network, but it will be understood as outlined that many approaches to the nature of devices and networks to be used for participation in the present invention are all contemplated within the scope hereof. It is explicitly contemplated where a wireless device on a wireless network was used to participate in the method that the identification details of a target data account could be the network address of the user device on that data network, via which the user devices in communication with the advertising server.

On initiation, the user can participate in an advertising session by, in an identification step, providing the identification details of a target data account of the user to an advertising engine software component on a server. The identification details of the target data account would be an account number, vendor details or the like, so the advertising engine software component could, with other components of hardware, software or by human intervention, apply earned credits to the target data account.

In certain cases, the identification details of the target data account might comprise or be generated from the network address of the user device which could be matched back to the target data account details of the particular data network provider. Many types of target data accounts and approaches to the capturing of identification details of same will be understood to be within the scope of the present invention. Besides providing identification details of the target data account, in certain embodiments of the present invention a user might also provide selection criteria or parameters which could fine-tune the selection of advertisements to be presented as options are for viewing by the user.

Following the identification step, the next step in the method is a selection step in which a selected advertisement record from an advertisement database would be selected, which corresponds to a selected advertisement to be shown to the user. In the selection step, the user can select the selected advertisement via a user interface of the user device of the user, or the advertising engine software component can select a selected advertisement record based upon the identification details of the target data account provided in the identification step, or other details of the user. Similar to the differing methods of initiation and advertising sessions, many types of manual or automated selection of the selected advertisement record will be understood to those skilled in the art and all are contemplated within the scope of the present invention.

The selected advertisement record could either be selected simply, randomly, cyclically or automatically by the software on server, or in other embodiments, selection criteria related to the user, the data network provider, the user device or other parameters could aid in the selection of the appropriate selected advertisement record. Where the user device is locationally enabled, geo-fenced limitations could be applied to the data set within the advertisement database to limit the advertisement records from which a selected advertisement record could be selected based upon locational availability or relevance.

Following the selection of a selected advertisement record, the selected advertisement would be shown in the user interface of the user device in a display step. Sometimes the advertisement itself might be interactive or could invite the capture of additional information from the user—if additional information was captured from the user, it would be transmitted from the user device back to the server for storage in relation to the results of the advertising session such transmission either taking place during the display of the advertisement, or upon completion of same.

In a completion step following the completion of the display of the selected advertisement on the user device, an earned credit would be selected to be awarded to the target data account based on credit criteria associated with the selected advertisement record, and the selected earned credit would be applied to the target data account. Relevant information from the advertising session might in certain cases be provided to the advertiser, and a payment transaction to the data network provider would be coordinated, regarding which they would receive compensation for the earned credit applied to the target data account. From a high-level, a user would identify a target data account, either by providing details of the account manually to the system or by automatic correspondence of a target data account with the address on a network of the user device used to view an advertisement or otherwise, selecting an advertisement to view and viewing same, following which time and earned credit will be selected and applied to the data account identified as the target account in the early identification step.

It is explicitly contemplated that the advertiser on whose behalf the selected advertisement is shown would directly or indirectly compensate the data account provider for the cost of the earned credit issued to the target data account. Effectively, the data network operators providing access to the system and method of the present invention would be providing qualified leads to the advertiser and on that basis it is explicitly contemplated that a premium advertising fee could be levied regarding the system and method of the present invention.

Besides the overall method of providing an earned credit to a target data account of the user for the viewing of an advertisement, a further step could be involved in which the system or the operator of the method would periodically provide the details of completed advertising sessions to the corresponding advertisers, potentially including identifying information of the viewers of those advertisements should that information had been provided.

Many approaches to the amount or value of the earned credit to be provided will be understood—including a system in which the value of the earned credit increases with additional personal information provided by the viewer to the system for provision to the advertiser.

The data network on which a user device is used to view an advertisement and participate in an advertising session by a user might be a different network than the network on which an identified target data account was resident. The number of data network providers or providers of target data accounts might be more than one.

A user device client software application might be provided for installation on user devices of users which could initiate and participate in advertising sessions by users—a user device software application might not be used and it might be possible to participate in the method of the present invention using a pre-existing interface or software—for example a browser or the like.

In one specific embodiment, a method of advertising wherein a user is compensated by applying an earned credit to a target data account of the user in exchange for viewing an advertisement on a user device could comprise the method of first providing an advertising server operatively connected to a network, which advertising server comprised an advertising engine software component capable of facilitating the display of advertisements to user devices on the network, and an advertisement database containing at least one advertisement record each corresponding to a particular advertisement of a corresponding advertiser for display to a user. The advertisement record would comprise identification of the advertiser, the data and processor instructions for the advertising engine to facilitate the display of a particular advertisement to a user device connected to the network, and credit criteria prescribing at least one type of credit which could be issued to the data account of the user for viewing the advertisement.

The data and processor instructions to facilitate the display of an advertisement might constitute the complete necessary content of the advertisement in question, or might sometimes constitute a link to the media files regarding the advertisement being resident in a remote network location or in another database—both such approaches again are contemplated within the scope hereof.

The server would also comprise a results database in this embodiment which contained a result record corresponding to each completed advertising session. Each result record comprises a link to the related advertisement record, identification of the target data account of the user having completed the advertising session, and details of the earned credit to be awarded to the target data account.

In this embodiment of the method of the present invention an advertising session itself would be conducted on initiation of same by executing the steps of first, in an identification step, providing the identification details of the target data account of a user to the advertising engine, either from the user interface of a user device or otherwise. In the next step of the method, the selection step, a selected advertisement record would be selected from the advertisement database which corresponded to a selected advertisement to be shown to the user, and showing or displaying that selected advertisement on a user interface of a user device and the user in a display step. Finally, in a completion step following the completion of the display of the selected advertisement on the user device, the earned credit to be awarded to the target data account based on the credit criteria associated with the selected advertisement record would be selected, a result record would be created in the results database which stored the identification details, details of the selected advertisement record and the details of the earned credit to be provided to the target data account, and following the creation of the result record, the earned credit itself would be caused to be applied to the target data account. As outlined above there are many automated and manual approaches to initiating an advertising session which are contemplated within the scope of this specific hardware and software enabled embodiment of the invention.

The selected advertisement record and the selected advertisement could be selected, in the selection step, physically or manually by a user of a user device via the user interface of the device, or in other circumstances, the selection step could comprise the advertising engine software component or other software within the server selecting the selected advertisement record and the selected advertisement based upon identification details of the target data account or other details of the user, their user device, demographic data or preferences, data network provider etc.

In certain embodiments of the method, the user might select from multiple available earned credit options depend upon the selected advertisement record and the credit criteria associated therewith.

The cost of the earned credit issued to the target data account would usually be paid to the data network provider by the advertiser, either directly or indirectly i.e. the data network provider could receive a payment directly from the advertiser, or the provider of the system and method of the present invention could act as a payment or billing intermediary.

During an advertising session the user could enter additional personal information via a user interface and that additional personal information could be stored to the result record corresponding to the advertising session for later provision to the corresponding advertiser. This could result in premium compensation.

A further step in the method of the present invention can comprise the periodic provision of the details of result records from the results database to the respective or corresponding advertisers. Where the results of advertising sessions are provided to advertisers, it might be desired to provide personal information of the users to the advertisers or in other cases it may be desired to provide the result records to the advertisers after first anonymizing them, to remove identifying information therefrom.

In certain cases the value of the earned credit provided to the target data account of the user could increase with additional personal information provided or other interaction by the user in the advertising session, or in other cases even dependent upon the length of the advertisement viewed or other factors.

The advertising server might also include at least one network gateway by which the advertising server can communicate with at least one data network provider hosting the target data accounts of users, to cause earned credits to be issued to the target data accounts of users. The number of data network providers in optimal embodiments of the present invention might be more than one, and the advertising server with its at least one network gateway is configured to communicate with each data network provider.

A user could initiate and participate in an advertising session manually from a user interface of the user device—either by pre-existing methods or using a local client application. In other cases, rather than an advertising session being manually initiated by a user of the user device, a prompt could be provided to the user of a user device from the network i.e. from a data server, the advertising server or another device they are all in. The prompt provided from the network could be prompted based upon the status of the target data account i.e. when the target data count is reaching a data cap or the like, or for any number of other different incentive reasons and any manual or automated initiation of advertising sessions as outlined will be understood to be contemplated within the scope of the present invention.

As outlined above regarding the general business method we explicitly assume the user device used to participate in an advertising session herein could be a wireless device such as a cell phone, tablet, computer which is connected to a wireless network, and the target data account of the user could be the wireless network account used by the user device.

### DESCRIPTION OF THE DRAWINGS

Selected preferred embodiments of the present invention will now be described referring to the drawings. In the drawings:

FIG. 1 is a flowchart demonstrating from a high level the steps involved in one embodiment of the business method of the present invention;

FIG. 2 is a schematic diagram showing one example of a system architecture or environment under one embodiment of the present invention;

FIG. 2A is a schematic diagram showing a second example of a system architecture or environment under another embodiment of the present invention, demonstrating payment gateway connections to remote data network provider servers and remote advertising content repositories;

FIG. 3 is a block diagram of the components of one embodiment of the advertising server of the present invention;

FIG. 4 is a block diagram of the key components of one embodiment of the user device under the present invention;

FIG. 5 is a block diagram of one embodiment of a data store and the relevant databases under the present invention;

FIG. 6 is a block diagram of one embodiment of the advertising engine software component of the present invention, showing the different software subroutines;

FIG. 7 is a flowchart showing the steps in one embodiment of an initiation transaction, initiating an advertising session between a user device and the advertising server;

FIG. 8 is a flowchart showing the steps in one embodiment of an identification step of the method of the present invention;

FIG. 9 is a flowchart showing the steps in one embodiment of a selection step under the method of the present invention;

FIG. 10 is a flowchart showing the steps in one embodiment of the display step of the method of the present invention; and

FIG. 11 is a flowchart showing the steps of one embodiment of the completion step of the method of the present invention.

### DETAILED DESCRIPTION OF ILLUSTRATED EMBODIMENTS

The invention comprises a method of advertising where a user is compensated for viewing of an advertisement on a user device, by application of an earned credit to a target data account of the user. By offering a credit to a data account, an advertiser can provide some compensation to the viewer both for the time and the financial cost of data account consumption and the viewing of video or multimedia advertisements, and the method will hopefully provide for an enhanced interactivity with users viewing advertisements.

### Advertisement Content:

The content of advertisements which might be shown in advertising sessions to users under the method of the present invention might comprise traditional short duration advertisements, or might comprise longer substantive content material which had advertising intermingled therein—it is explicitly contemplated that the longer format content might be beneficial in the context of for example users who were travelling, agreeing to watch some advertisements within the context of watching a movie streamed to their device, and receiving enough data account credit to negate any cost to their watching of the movie. The content which could comprise multimedia or streamable content to a user device under the remainder of the present invention will be understood to those skilled in the art of multimedia content development and any type of a viewable content which could be downloaded, streamed or displayed on a network connected user device is contemplated within the scope of the present invention.

### Target Data Account:

The underlying concept of the method of the present invention is that a user can earn the application of a service credit to a target data account for viewing an advertisement. The earned credits can take many forms but the advertiser would compensate the user by providing them with a credit either equivalent to or over the “cost” of the data service consumed by the user on the user device and its network, to download, stream or view the advertisement. The target data account as discussed herein is the data account of the user to which the earned credit would be applied.

The target data account might be the network data account used by the user device and viewing the advertisement, or sometimes the target data account can also be another data account beneficially held by the user on or in relation to the same or another data network provider as the data network provider providing service to the user device used in the advertising session in question. One example of the remote configuration might be that a user could view an advertisement in an advertising session on a desktop computer, but the target data account to which they might wish to earn a service credit could be their wireless device data account.

The target data account would be identified by the user either automatically or manually when the advertising session was initiated, so the server could identify the target data account and the data network provider coordinates to allow for the proper awarding of the earned credit earned by the user for viewing the advertisement.

The method of the present invention is specifically contemplated to be operable using either fixed computers or viewing hardware, or wireless user devices. With either a wireless user device or fixed hardware, both such devices would require a network connection to the Internet or to the wide area network over which the general method would be practiced or provided. Where each such device would have a network connection, those network connections would likely be provided by one or more data network providers, and the user or the user device would have a network access account assigned thereto. The network access account assigned or provided by the data network provider in question could be the target data account to which data or other types of earned credits could be applied.

### Earned Credit Options:

The earned credit that might be applied to a target data account for viewing an advertisement on a user device might be a credit to their consumption based data account of a data network provider, at least equivalent to data consumed to view this advertisement—for example if streaming a particular advertisement under the remainder of the method of the present invention consumed 1 GB of network traffic, which presumably the user would be paying for through their data network account arrangements with their data network provider, under the method of the present invention the earned credit which might be provided back to the target data account of the user might be to provide a credit in the amount of 1 GB of network traffic, or to effectively incent or at the very least compensate with parity the user for data consumption used to view the advertisement.

Where the earned credits will be effectively reimbursement of data consumption, there are several types of approaches which can be taken besides the issuance of a data consumption credit to the data network account of a user provided by a data network provider. In certain cases, the earned credit arrangement might automatically generate a direct payment transaction between the data network provider of the target data account and the advertiser in question whereby the advertiser would pay the data network provider directly for data consumed in the streaming of a particular advertisement. This would allow for the viewing of advertisements by users on the user devices without even requiring debiting and crediting of data consumption amounts to their direct target data account or their user data account. Any type of a data credit as an earned credit, wherein a user is compensated with a data credit applied to a target data account in exchange for the viewing of an advertisement on the user device will be understood to be within the scope of the present invention, whether that results in debiting and crediting of data consumption costs and amounts to the target data account, or other cases where the advertiser would pay the data network provider of the target data account directly for an amount of data consumption used in the viewing of the advertisement in question.

As outlined elsewhere herein, many types of earned credits could be provided to a target data account under the method of the present invention. Earned credits to be provided to the target data account might be selected from at least:
Extending the capacity limit of the target data account by at least the network capacity required to view the advertisement;
Crediting the capacity limit of the target data account by at least the network capacity required to view the advertisement;
Not charging the capacity limit of the target data account by at least the network capacity required to view the selected advertisement;
Enhancing the networks speed provided to user devices using the target data account;
Providing enhanced quality of service to user devices using the target data account; providing access to exclusive network content to user devices using the target data account;
Goods or services of the data network provider of the target data account or a selected advertiser or third-party.

### Data Network Providers:

Data network providers referenced would be any data network provider who provided endpoint access for user devices to the central network via which the method of the present invention was practiced. With hardwired or fixed access devices such as computers or the like, the data network provider might be the provider of Internet service to the particular premises or location of that equipment.

With the user device being a wireless device such as a smart phone, tablet etc., the data network provider might be the wireless network provider who provided network access to the user device. The target data accounts as outlined elsewhere herein could be the data accounts used by user devices to gain network access to view advertisements in advertising sessions under the remainder of the method, or they might be target data accounts on the same or other data network provider networks other than the data accounts used by user devices to view advertisements within advertising sessions—both such approaches are contemplated within the scope of the present invention.

Where the data network provider provided network access on a metered or consumption basis, the earned credits might be related to compensating or rebating the consumed data network bandwidth etc. which was consumed in viewing an advertisement. Where the data network provider provided service to the user at a fixed fee, other types of data account related credits can also be provided—enhanced service speed, quality of service etc. Several different options again are outlined above.

### Credit Criteria:

One key element of the method of the present invention is the ability of the method of the present invention to select the appropriate earned credit for application to the target data account based upon criteria associated with the particular selected advertisement viewed in an advertising session—different advertisers may be prepared to provide different qualities, quantities or values of earned credits dependent upon things ranging from the particular advertisement viewed through to the level of interactivity or information provided by the user within the advertising session.

In some embodiments, the user, via the interface of their user device, could be allowed to select from available earned credits they wanted to earn to their target data account, or in many other cases, based upon the credit criteria associated with the particular advertisement record in the advertisement database the particular earned credit to be provided would be automatically selected for application to the target data account.

In further embodiments of the present invention, an advertiser may wish to stack the available earned credits i.e. they may be prepared to compensate a user with more than one type of earned credit for the viewing of a particular advertisement or participation in a particular advertising session. This again could be accommodated by the storage of the credit criteria in association with the selected advertisement record.

The credit criteria stored in relation to a particular advertisement record in the advertisement database might also include the information or details to facilitate payment transactions between data network providers and the provider of the advertising server or directly between data network providers and the selected advertisers—this additional information will also be understood to those skilled in the art of e-commerce system design and any such modification or enhancement to the basic core of the system of the present invention to accomplish this aspect of the proposed invention will be understood to be within the scope hereof.

### Selection Criteria:

Besides the credit criteria, certain embodiments of the system and method of the present invention may also comprise the storage of selection criteria in relation to one or more of the advertisement records—selection criteria could be used in filtering or enhancing the granularity of the selection of a selected advertisement record based upon environmental variables including the user, user device type, geographic location of the user of the user device, or any number of other demographic or personal details which might even be stored in personal profile of the user or provided by the user on initiation of the advertising session.

In basic embodiments of the method of the present invention selection criteria may not be used—a random or automated process may provide a more basic selection system to render selected advertisement records, but where one or more selection criteria were stored regarding advertisement records and the advertisement database these could be used with the user, data network provider, target data account or other criteria in the selection of a selected advertisement record.

In another example if an age gateway or threshold was imposed upon the availability of a particular advertisement, besides capturing the age of users directly or in relation to a profile, the threshold age at which that advertisement and its related advertisement record could be made available might be stored as the selection criteria with respect to a particular advertisement record.

Where legislation or other requirements were such that advertisements can only be shown to users within a particular jurisdiction or who were permanently resident within a particular jurisdiction, the selection criteria being the address or location of the user might be compared to selection criteria including a geo-fence around the jurisdiction from within which the advertisement can be viewed—these are just two additional examples of selection criteria scenarios, many others of which will be obvious to those skilled in the art and are all contemplated within the scope of the present invention.

### Method Overview:

An advertising server would facilitate the viewing of an advertisement of a selected advertiser on the user device of the user, and following the completion of the viewing of the advertisement or any other interaction with the advertisement as required or desired, an earned credit would be applied to the target data account in question.

The method is accomplished by first providing an advertising server operatively connected to a network. The advertising server comprises an advertising engine software component capable of facilitating the display of advertisements in advertising sessions to user devices on the network with a data store containing a series of databases or datasets which are required for the practice of the method.

The advertising server would also comprise locally or by connection an advertisement database comprising at least one advertisement record corresponding to a particular advertisement of a corresponding advertiser for display to users. Each advertisement record would identify the advertiser, along with containing the data and processor instructions for the advertising engine software component to facilitate the display of the advertisement to a client device connected to the network, and credit criteria which prescribe at least one type of earned credit which could be issued to the target data account of the user upon completion of the viewing of the advertisement in question.

Besides the advertisement database, the system would also comprise a results database containing a result record corresponding to each completed advertising session. Each result record would contain a link to the related advertisement record, identification of the target data account of the user having completed the advertising session, and details of the earned credit to be awarded to the target data account.

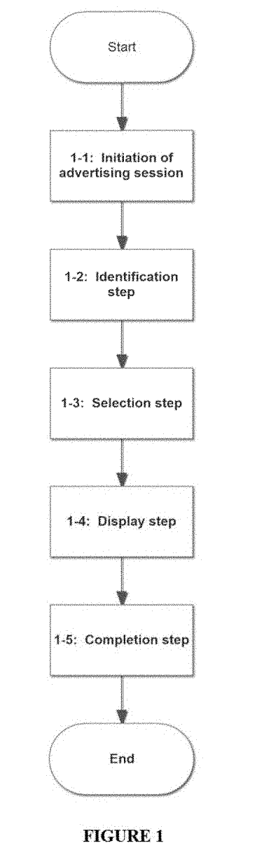

Referring to FIG. 1 there is shown a flowchart demonstrating the high level steps of the method of the present invention—the first step in the method of the present invention is the initiation of an advertising session initiated either by triggering by a user of the user device, or in other circumstances an advertising session can be initiated based on a prompt generated by a network device, being the advertising server itself or a server or network connected device of an advertiser or a data network provider or otherwise, who could initiate a communication session or triggering an advertising session in communication with the user device and a user. The different specific contemplated methods of the triggering or initiation of advertising sessions are described in further detail elsewhere herein and any type of an initiation step or a triggering step, whether that be a manual triggering by the user of a user device, or whether it be initiated by a prompt or a trigger from a device on the data network to which the advertising server and the user device or connected are all contemplated within the scope of the present invention. The initiation of the advertising session is shown at step 1-1 in FIG. 1.

On initiation of the advertising session, an identification step is conducted, where the identification details of the target data account of a user are identified to the advertising engine software component. The target data account, as outlined elsewhere herein, is a data account of a user on the network or provided by a data network provider regarding which service or financially related earned credits could be applied in exchange for the viewing of advertisements.

The target data account could sometimes be identified to the advertising engine software component by a manual data entry process from the user at a user device i.e. whether that be authentication to a user profile, entering a phone number or a network address of this account, or conducting some other a manual data entry step. In other circumstances, particularly where the target data account was for example going to be the data account associated with the user device being used by the user at the time to access and view the advertisement and participate in the method, the identification details of the target data account could be automatically captured for example by capturing the network address for the data account particulars associated with the user device being used by the user.

Automatic capture of the network address or other target data account particulars associated with the user device being used to view an advertisement in association with the invention will be understood to those skilled in the art of network design and similar data capture. The identification step is shown at step 1-2.

Following the identification of the target data account to the advertising engine server component in the identification step, the next step in the method is a selection step, shown at step 1-3. The selection step represents the selection of a selected advertisement record from the advertisement database which corresponds to a selected advertisement to be shown to the user. Selection of the selected advertisement record could again be done in many automated or simplified ways—everything from simply randomly or cyclically selecting an available advertisement record, to more advanced selection methods where the record selected was selected based upon parameters or qualifications of the user, the user device, the target data account particulars, the data network provider etc. will be understood to be within the scope of the present invention.

In other cases or embodiments of the system and method of the present invention, the advertising server might include a user profile database in which recurring users of the system could actually establish a user profile against which they could manually or automatically authenticate to identify their preferred target data account and/or capturing or profiling other information which could be used as selection particulars to fine tune the selection of desirable selected advertisement records for viewing by them.

Where the user device is locationally aware, another type of criteria which could present available advertisement records from which a selected advertisement record could be selected would be to provide geographically relevant advertisements—for example based upon detection of a particular location, the advertisement record which might be selected as the selected advertisement record might automatically be an advertisement for a nearby restaurant, shopping outlet or the like.

Device compatibility could be another selection criteria based upon which the selected advertisement record could be selected—in certain cases either based upon the type of the device being used by user or even based upon network bandwidth or services, certain devices might be able to display the content of the advertisements corresponding to the advertisement records in the advertisement database.

Any number of different advertising selection approaches are contemplated within the scope of the present invention—everything from the simplest automated or random selection of a selected advertisement record from the advertisement database, through to the selection of a more relevant advertisement for viewing by this particular user by application of selection criteria are all contemplated within the scope hereof.

Once a selected advertisement record has been automatically selected by the advertising engine software component on its own, or has been selected by interaction between the advertising engine software component and the advertising server and a user device and the user by the interface of that device, the next step in the method is a display step, shown at step 1-4. The display step effectively comprises the display of the corresponding selected advertisement of an advertiser, which corresponds to the selected advertisement record, on a user interface of the user device of the user. The selected advertisement itself could be video content or other types of multimedia content. Any type of an advertisement which could be viewed on different user devices is contemplated within the scope of the present invention.

The display of the advertisement itself will typically take place based upon either playback in an available browser software on the user device, or if a local client application is installed that can also display the content in question.

The media content files required for playback of these advertisements could be stored directly within the advertisement database of the advertising server, or the advertisement records in the advertisement database could also link to externally store media content.

In certain cases, during the playback of the selected advertisement user interaction may be invited—for example if the advertiser wished to engage the viewer in some type of a second level of interactivity beyond viewing their advertisement, which they believed would provide more value to them. Similarly, in certain cases either during or following the display of the advertisement the advertising session may invite the capture of personal information from users—such as demographic information—which could be recorded with the remainder of a result record in the results database and/or could be provided to the advertiser.

Where such information was provided by a user in the viewing of an advertisement, again in compensation for that added interactivity or for provision of that added information, the “value” of the earned credit provided to the target data account could be increased, or the earned credits provided could be enhanced—based upon the credit criteria stored in association with the selected advertisement record.

Following the completion of the display of the selected advertisement on the user device, the final step in the method is a completion step—shown at step 1-5 in the Figure. Following the display of the selected advertisement on the user device, the earned credit to be awarded to the target data account would be selected, based upon the credit criteria associated with the selected advertisement record. The particular type of an earned credit which could be provided to a user might be a single type of an earned credit, might vary by data network provider or might very by other types of criteria—any type of options which could be provided in one or more earned credits from which a user can manually select of the system could select for application to this target data account are contemplated within the scope of the present invention.

Following the selection of the earned credit to be awarded, a result record will be created in the results database which stored the identification details of the target data account, details of the selected advertisement record including any captured additional information provided by the user within the advertising session, and the details of the earned credit to be provided to the target data account.

Finally, the advertising server and the advertising engine software component could through communication directly with the server of the data network provider of the target data account or even sometimes by a manual process cause the earned credit to be applied to the target data in question.

Within this general framework of the method of the present invention, there are many permutations and combinations of services and approaches which can enhance the core service offering of the method and which are outlined in further detail below.

### Illustrative Environment and System Architecture:

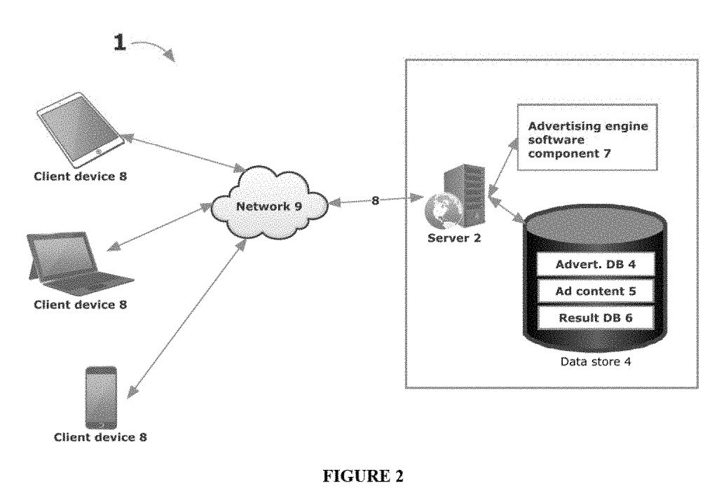

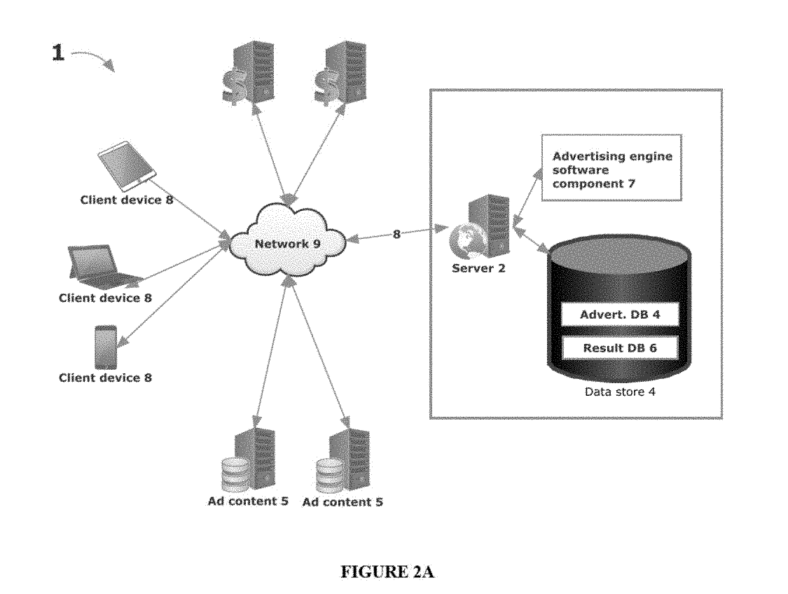

FIG. 2 shows one example of an architecture of a system 1 under the present invention. User devices 8 would interact with an advertising server 2 to serve advertising content in advertising sessions, and initiate the application of earned credits to the target data accounts of users at appropriate times. The advertising server 2 might include various software applications to manage aspects of interaction between various components of the system 1, the server 2 or the user devices 8.

The advertising server 2 would include an advertising engine software component 7, responsible for the administration and handling of the method of the present invention. The server 2 would host a data store 4 which hosted or linked to at least two databases, being an advertisement database 5 and the results database 7. Here a separate data structure being an advertising content repository 6 is also shown although this material can also be stored directly within records and the advertisement database 5. As outlined elsewhere herein, the hosting of the actual advertising content either directly within the data store accessible to the server 2, or as one or more remotely stored records corresponding to the advertisement records within the advertisement database 5 are both approaches contemplated within the scope of the present invention.

The advertisement database 5 would comprise a plurality of advertisement records each of which corresponded to a particular advertisement of a corresponding advertiser to be displayed to users under the remainder of the method.

The results database 7 comprises a plurality of result records corresponding to completed advertising sessions, each of which comprises the necessary information to identify a target data account of the user having completed the session along with details of the status etc. of the earned credit to be awarded to the target data account.

The data store 4 could comprise a single multifaceted data file or multiple data files or databases within a data store 4 on the server 2, or in some embodiments one or more database components of the data store 4 might be connected by a data bus or by network to the server 2, either locally or remotely. All such approaches are contemplated within the scope of the present invention.

User devices 8 would connect to the advertising server 2 via a wide area network 9 [most likely the Internet—wherein the data networks of individual data network providers are subnets attached thereto]. The network 9 could be any type of a communications network capable of communication between the user devices 8 and the server 2. The network 9 as shown can also be a combination of multiple networks each of which of similar or different typologies, such as cable networks, local area networks, personal area networks, wide area networks, the Internet, wireless telecommunications networks, ad hoc networks, mesh networks and the like.

It is explicitly contemplated that where the method is practiced with multiple user devices 8 those multiple user devices 8 may connect to the server 2 via multiple data network entry points—for example where the user devices 8 comprise wireless devices such as smart phones, tablets or the like with wireless modems contained therein, each user device 8 might be connected to a separate wireless network, which on its back and was operatively connected to the same server 2 via a central Internet or other wide area network.

For demonstrative purposes, the architecture in FIG. 2 shows the advertising server 2 with three user devices 8—being a smart phone, a notebook computer and a tablet computer. These components are shown purely for demonstrative purposes it will be understood that many different network architectures without departing from the intended scope.

The advertising server 2 of this Figure includes or is operatively connected to at least one communications or payment gateway via which information can be transmitted to the processing systems of at least one data network provider, to apply earned credits to these target data accounts. The communications or payment gateway would comprise software, hardware or a combination thereof capable of communicating with transaction systems of one or more data network providers to at the appropriate time in completing an advertising session trigger the application of an earned credit to the target data account of a user.

FIG. 2A demonstrates an alternate example of the system architecture of FIG. 2 in which two modifications to the network or the architecture are demonstrated—the first of which is the remote location of the advertising content repositories 5—as discussed elsewhere herein, the actual multimedia files required to stream or display an advertisement to a user device 8 under the remainder of the method of the present invention could be stored locally within the data store 4 accessible directly and locally to the advertising server 2, or in other cases, the advertising content repositories 5 can be remotely located—for example the advertiser themselves might be responsible for maintaining their advertising content files and the related advertisement record in the advertisement database 4 might simply include a link to the location of those files which can trigger the display of same. In this Figure, the remote location of the advertising content in databases or repositories 5 on two remote servers is shown. It will also be understood that in further embodiments of the architecture of the present invention, there could be a hybrid approach taken whereby some advertisers content files could be stored within the data store 4, and other advertisers who wish to maintain the file remotely could do so as shown in this Figure.

The second difference in the embodiment of FIG. 2A is a plurality of data network provider servers—shown as e-commerce servers—which would be in this embodiment network connected to the network 9 so the advertising server 2 could communicate with them. At the appropriate time the advertising server 2 could instruct or facilitate the application of an earned credit to a target data account of the user being a target data account of a data network provider having a server accessible to communicate with the advertising server 2. In some embodiments of the present invention, the data network provider servers might also be used with the advertising server 2 for lookup purposes or for other purposes within the execution of an advertising session—again any type of a network architecture which accomplishes the primary goal of enabling communication between the advertising server 2 and the transaction systems of at least one data network provider who would be the provider of a target data account to which it was desired to apply earned credits under the remainder of the present invention are contemplated within the scope hereof.

### Advertising Server:

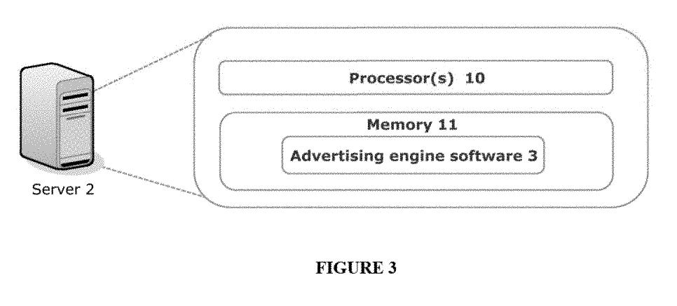

The advertising server, a sample embodiment of which is shown in FIG. 3 might comprise one or more advertising servers 2—a single server or a server farm approach. The advertising server 2 would comprise one or more processors 10 and memory 11. The memory 11 might contain various software components or processor instructions for the method of the present invention or otherwise in operating the advertising server 2. Processor instructions corresponding to the advertising engine software component 3 are shown stored within the memory 11 in this Figure.

In many embodiments of the method of the present invention the advertising server 2 is contemplated to be a Web server or a web enabled server, where user devices 8 could use a web browser or similar software to interact with the advertising server 2. In other cases, a local front-end client application could also be provided for use on user devices 8, in which case the advertising server 2 may not need to have Web server capabilities per se but might be a server 2 in those cases capable of interaction with the type of an interface provided by such a remote client software application. Either such approach is contemplated within the scope of the present invention.

The server 2 would host or be operatively connected to the data store 4 which contains the advertisement database 4 and the results database 6. Besides the general operating system instructions the advertising server 2 would also comprise an advertising engine software component 7 which would be responsible for execution of the method of the present invention of the server and, and would coordinate communication with user devices 8 of users seeking to participate in advertising sessions.

The advertising engine software component 7 would comprise subroutines to administer the databases 4 through 6, creating and modifying transactions and records in the data store 4 in interaction with user devices 8 of users, and additional financial or numerical transactions, searches or reporting as required. The details of operating the advertising engine software component 7 are outlined elsewhere herein.

The advertising server 2 might also be capable of communication with the financial or account management systems of data network providers who provide target data accounts of users, so the advertising server 2 could during the completion step of a particular iteration of the method of the present invention initiate the processing of an earned credit to a target data account related to the system of a particular data network provider—any number of different financial system interfaces will be understood to those skilled in the art of payment processing and related system design and any such approach which would allow for the processing of earned credits to target data accounts of one or more data network providers will be understood to be within the scope of the present invention.

### User Device:

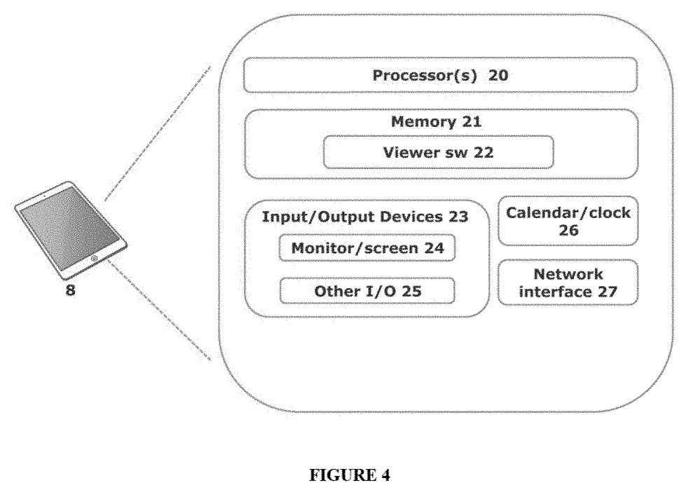

The method of the present invention explicitly contemplates the use of network enabled user devices 8 by users to participate in advertising sessions in communication with an advertising server 2, using a user device 8. FIG. 4 is a schematic block drawing of one such user device 8 which could be used under the remainder of the method of the present invention—a tablet computer is shown. Any type of a user device 8 which could communicate with the advertising server 2 via a network and the related network interface would be within the scope of the present invention.

The user device 8 shown includes one or more processors 20 and a memory 21. The memory of the user device 208 might include various types of processor instructions either for assistance in the execution of the method of the present invention or for other activities to be undertaken using the user device 8. The memory 21 would include browser or viewing software 22 which could facilitate the viewing of an advertisement by the user via the user device 8 with the advertising server 2 and the remainder of the method and system of the present invention.

The user device 8 includes a network interface 27, by which the user device 8 can communicate via a data network with the advertising server 2. The user device 8 might, as with many portable wireless devices of current state, include GPS or location sensing technology which could acquire location coordinates for the location of the user device 8 so location-based advertising selection criteria could be applied in determining available advertisements and advertisement records from the advertisement database to be used in the administration of an advertising session with that user and that user device 8. Any location sensor or combination of hardware and software which can yield a location reading could be encompassed herein in that regard.

The user device 8 also includes a plurality of input and output devices 23, many of which are required for the user device 8. The first input output device required for the method of the present invention would be a user display or interface 24 which would allow for the display of information related to advertisement records from the advertisement database 4 to the user of the user device 8 in an advertising session. Some user devices 8 could also include a keyboard or other input output devices 25.

It is explicitly contemplated that the user devices 8 of the present invention would likely be smart phones, tablets, personal computers or the like with the appropriate browser a viewer software 22 installed thereon. The majority of commercially available hardware devices include all the hardware and software components to participate in the method of the present invention.

### Communications Network:

We specifically assume the communications network 9 used for communication between the server 2 and the user devices 8 would be the Internet or another publicly available wide area network. Specific communications protocols for communication between user devices 8 in the server 2 can vary, and different communications protocols which can be used in this type of an architecture will be understood to those skilled in the art of wide area computer network design and all such approaches are contemplated within the scope of the present invention.

### Data Store:

In the sample architecture diagram in FIG. 2 there is shown a data store 4 operatively connected to the remainder of the advertising server to which contains the various datasets required for operating the method of the present invention. Specifically, the data store 4 as shown contains or hosts the advertisement database 4, the advertising content database 5 and the results database 6, each of which comprise a plurality of records as outlined in further detail elsewhere herein. The databases could each either comprise a subset of a consolidated data store 4 such as shown here, or might be represented by individual databases or data stored separately within the memory or storage of the server 2 or operatively connected but remotely located thereto. Both such approaches will be understood be within the scope of the present invention. Any type of a data structure capable of storing the various information for these data subsets in respect of advertisements, advertising content and the results of advertising sessions completed under the method of the present invention are contemplated herein.

The particular construction or data structure of the data store 4 or individual databases might also depend on other aspects of the infrastructure design of the remainder of the system of the present invention. Again, the various aspects of the system, and structure in its databases including those which are infrastructure dependent will be understood to those skilled in the art of relational or flat file database and client/server system design and are all contemplated within the scope of the present invention.

### Advertisement Database:

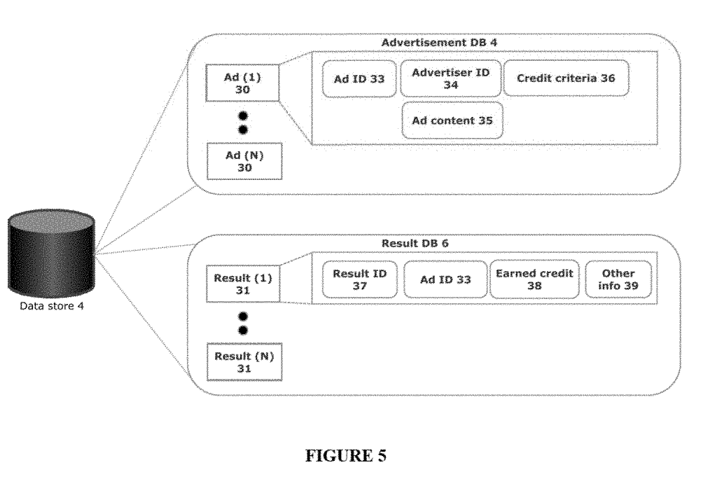

FIG. 5 shows one embodiment of a data store under the invention to demonstrate basic concepts of the anticipated data structure. The advertisement database 4 comprises a plurality of advertisement records 30 each of which pertains to an individual advertisement of a selected advertiser which it is desired to show to users for their participation in the method of the present invention. Each advertisement record 30 within the advertisement database 4 would comprise the necessary profile and content information to facilitate an advertising session with a particular advertisement of a selected advertiser. The number of advertisement records 30 within the database 4 could vary, as shown in FIG. 5—1 through N advertisement records 30 are shown, each of which corresponds to the advertisement of an advertiser.

The details of the structure and content of each advertisement record 30 could vary depending upon the deployment or development of the particulars of the system of the present invention, but each advertisement record 30 would include an advertisement identifier 33 or a similar database key which could be used for identifying the particular advertisement record 30 in operation of the remainder of the software and method of the present invention and to link the advertisement record 30 to other records and other datasets in the database.

Besides the advertisement identifier 33, advertisement records 30 would also include identifying particulars of the advertiser 34 regarding whom a particular advertisement record and its related advertisement would be shown. Advertiser particulars 34 stored within an advertisement record 30 could be virtually any information it was desired to retain for record-keeping or method purposes regarding the advertiser on whose behalf the advertisement represented by the particular advertisement record 30 existed. The advertiser particulars 34 might explicitly include commercial payment details which could facilitate commercial payment transactions and advertisers and data network providers in the awarding of earned credits to target data accounts.

Besides the advertiser identifying particulars 34, the advertisement record 30 will also include the advertisement content 35. This could either comprise the files and/or data processor instructions to enable the advertising engine software component 72 to stream a particular advertisement for viewing to the user device of a user, or in other cases as outlined elsewhere herein might simply comprise a link to externally hosted or stored content or files. Both such approaches are contemplated within the scope of the present invention. Finally, the advertisement record 30 shown also includes credit criteria 36—the credit criteria 36 as outlined elsewhere herein would be the information for the advertising engine software component 37 to select and award earned credits to users for viewing of the advertising content 35 associated with a particular record 30.

In some embodiments of the database 4 of the present invention, advertisement records 30 might also include selection criteria, being filtering data or values which could limit the availability of a particular advertisement record 30 for selection as a selected advertisement record regarding a particular initiated advertising session with the user device of the user.

As shown in the architecture of FIG. 2, an advertising content repository or advertising content database 5 is shown as a portion of the data store accessible to the advertising server 2. In other cases, such as the data structure demonstrated in FIG. 5, the actual advertising content for selected advertisements is shown is stored within the respective advertisement records 30.

It will be understood to those skilled in the art of web application design and database structure and programming that any number of different approaches could be taken to the construction, structure and population of the advertisement database 4 and the method outlined above or any number of different embodiments as will be obvious to those skilled in the art here from are all intended to be within the scope of the present invention and do not depart from its intended purpose.

### Results Database:

The second dataset of the present invention shown in the Figures is the results database 6. The results database 6 contains a result record 31 regarding each completed advertising session administered under the method of the present invention—for record-keeping and also for the final work of ensuring the processing or awarding of whatever earned credits are required, to the target data account of the user having viewed this advertisement. The results database 6 would contain a plurality of result records 31—FIG. 5 shows one embodiment of the basic data structure which could be used for results database 6 and a plurality of result records 31, 1 through N, are shown.

In the embodiment shown in each result record 31 includes a result record identifier 37 or some other type of a database reference key, and an advertisement ID 33 which is a link back to an advertisement record 30 in the advertisement database 4.

Besides the advertisement identifier 33, the result record 31 as shown includes the details of the earned credit 39 earned by the user for viewing the advertisement question with other information shown on 40. The other information 40 would include details of the target data account which the earned credit 39 was to be applied.

In an embodiment of the system of the present invention which users used user profiles, where there might actually be a user profile database within the data store 4, this information 40 might include a record link to that other database or profile information. Overall the contents of a result record 31 would be the necessary information to report back to the advertiser of a particular advertisement record 30 about a session viewing their advertisement having taken place, and to contain all the information to issue the selected earned credit 39 to the target data account of this user.

Where the advertisement content 35 of a particular advertisement record 30 was interactive or would cause the capture of interaction or personal information, enhancing the earned credit availability or otherwise, the captured information or interactivity results may also be stored in the result record 31 with the other information 40, for reporting, provision to the advertiser or other purposes.

### Advertising Engine Software Component:

The functions of the advertising engine software component 7 would include the creation and administration of advertisement records and result records within the data store 4, and interaction with users by their user devices in advertising sessions conducted in communication with the advertising server 2. Each function or module of the advertising engine software component 7 could be a freestanding software application or subroutine within a memory or storage on the server 2, or they can all be functions of a consolidated software program—and any approach is contemplated within the scope of the present invention.

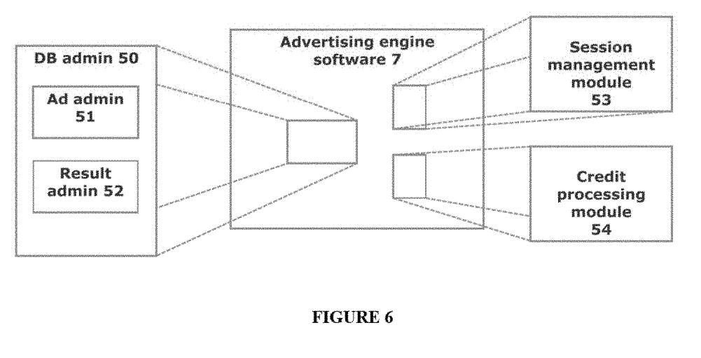

Overall, the creation and administration of records in the databases 4, 6 would be conducted by a database administration module 50. The database administration module 50 could have a number of sub functions or subroutines therein, for the administration of advertisement records, result records etc.—these record administration subroutines are shown in FIG. 6 as elements 51 and 52. Each of the database administration subroutines 51, 52 might also be called upon by other components of the advertising engine software component 7 to query, extract or report upon the contents of their respective databases.

Besides the overall database administration module 50 and its related subroutines, the processor instructions accessible to the server 2 would also include software instructions to allow for the communication of the advertising server 2 with user devices 8 via the network connection of the server 2.

Also shown in the software embodiment of FIG. 6 is a session management module 53 contemplated to comprise the processor instructions for use by the advertising server 2 in communication with user devices 8 within the context of actual advertisement sessions i.e., initiating sessions, displaying advertising content to user devices and at the close of an advertising session creating the result record etc. The session management module 53 might include numerous subroutines for the conduct of different system transactions related to the administration of advertising sessions with users by other user devices.

Also shown in this embodiment is a credit processing module 54 which might be a freestanding subroutine within the advertising engine software component 7—which would accomplish the related system transactions and reporting etc. which must trigger and confirm the application of credits to the target data accounts of users having participated in advertising sessions. The functionality of a credit processing module 54 could also be a part of the session management module 53—it will be understood that the software to facilitate the issuance of credits via the network to the data network providers of these target data accounts is an important function of the advertising engine software component 7 and any approach to the overall method of the present invention which results in the ability of the system to provide this final processing of earned credits at the tail end of advertising sessions or on a periodic basis based on result records created in the results database are all contemplated within the scope hereof.

### Payment Gateway:

The advertising server 2 either within the advertising engine software component 7 or as a freestanding software or hardware combination would also include or access a payment or transaction gateway through which earned credits could be processed onto the target data accounts of users on the systems of data network providers. Either immediately upon completion of an advertising session or on a periodic basis, the server 2 could initiate the issuance of an earned credit by transmission of a credit application instruction to an automated server or network interface of the accounting system of the data network provider responsible for a target data account to which an earned credit was to be applied. The data network provider could be financially compensated for the earned credit to be applied by the operator of the advertising server 2 with an appropriate commercial relationship and transaction structure in place, or in other cases the instruction of applying an earned credit by the advertising server 2 to the network interface of a data network provider could also include the facilitation of a direct payment transaction from the advertiser whose advertisement was watched in the related advertising session, to the data network provider, in the amount of the value or agreed-upon amount to be paid for this earned credit.

In other cases, a payment gateway may not be present or may not be used for automated application of credits and it may be necessary to facilitate the application of earned credits manually or by forwarding reports etc. to these data network providers—many types of payment processing approaches will be understood by those skilled in the art of e-commerce system design and any payment gateway approach which results in the ability of the advertising server 2 and the rest of the system to facilitate the application of an earned credit to a target data account on the account system of the data network provider, in completion of an advertising session, will be understood to be contemplated within the scope of the present invention.

### Initiation of Advertising Sessions:

An advertising session could be initiated by user from a user device, selecting to view an advertisement in an advertising session to obtain an earned credit to their target data account, or in other cases it will also be understood that network devices operatively connected to the server or indirectly to the user device or user devices in question could also prompt or trigger the initiation of an advertising session.

For example, the user from the user device could initiate an advertising session either using a locally installed client software or by dispatching an SMS message, clicking a browser link or otherwise, requesting to commence an advertising session with the server, or in other cases it might be the case that either the advertising server or even a third party network device could prompt a user at their user device or elsewhere about whether they wish to engage in a advertising session—for example if a data network provider detected on their account records for the user network account of a user device that that user network account was approaching a data consumption limit, the data network provider might trigger an offer of an advertising session to the user device of the user again either using a locally installed client software on the user device or by dispatching a message through other channels through which the advertising session could be. Any approach to the method of the present invention which allowed for either a user directly from a user device to proactively initiate or request the commencement of an advertising session, or by a network device providing a prompt to the user device which resulted in the ability to open a communication session between the user device and the advertising server and commence an advertising session are all contemplated within the scope of the present invention.

The following is considered a nonexhaustive listing of scenarios initiating advertising sessions between the user and the user device, and the advertising server of the present invention [with the changes to the delivery framework between local client software and pre-existing browser software etc. as might be obvious and required for the delivery of a particular initiation scenario]:
1. The user manually initiates an advertising session by requesting same in a local client application connected to the advertising server;
2. The user manually initiates an advertising session by activating a browser link which transmits an advertising session request back to the advertising server;
3. The user initiates the transmission of a message—SMS, email or the like—to the advertising server requesting the initiation of an advertising session;
4. Local client software on a user device of a user transmits a request for initiating an advertising session to the advertising server based upon locally detected conditions or parameters—geographic location, schedule, time, user details or the like;
5. The advertising server initiates an advertising session based on preprogrammed criteria—schedule based etc.—resulting in the automated opening of an advertising session with a user device of the user;
6. A network device of a data network provider communicates with the user of a user device associated with a particular network data account of the data network provider [for example by providing a local modification or prompt, SMS message, email or other type of communication which allowed for automated or manual initiation of the transmission of an advertising session request to the advertising server], querying whether the user wants to initiate an advertising session to obtain an earned credit to this data account;
7. A network device of a data network provider provides a prompt offering the option of participating in an advertising session to obtain an earned credit to the network data account of a wireless device to the user of the wireless device, where it is detected that the network data account of the wireless device is approaching exhaustion or limits in data credits or service availability, and if the user elects to do so and advertising session is commenced between the advertising server and the wireless device;
8. A network device of an advertiser could communicate with the user of a user device [for example by providing a local modification or prompt, SMS message, email or other type of communication which allowed for automated or manual initiation of the transmission of an advertising session request to the advertising server], querying whether the user wants to initiate an advertising session to obtain an earned credit to a data account;

It will be understood this list is not to be exhaustive and there may be other scenarios or frameworks within which advertising sessions can be initiated between a user device and the advertising server—these would generally fall within the category of manually initiated or user initiated advertising sessions, versus system or network prompted initiation requests which could be initiated or prompted either by the advertising server, a network device associated with an advertiser, or a network device associated with a data network provider.

Where an advertising session was initiated between a user device and the advertising server, this would physically comprise the step of creating a communication between those two devices for two-way communication between the user device and the advertising server, whereby identifying information of the target data account etc. can be transmitted from the user device to the advertising server, and the advertising server directly and with any remote advertising content repository can facilitate the serving of actual advertisement content related to the selected advertisement record to the user interface of the user device.

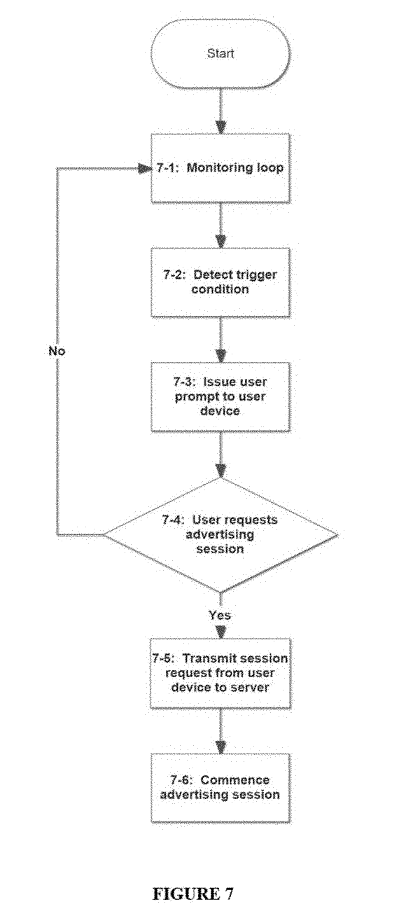

Referring to FIG. 7 there is shown a flowchart demonstrating the steps in one embodiment of a method of triggering the initiation of an advertising session under the remainder of the method of the present invention. In the embodiment of FIG. 7, this should demonstrate a network prompted or network driven initiation request, where a network connected device would prompt a user of a user device to consider initiating an advertising session to receive an earned credit to their target data account. Specifically, for the embodiment demonstrated in this Figure, it could be that the user device was a wireless device and the target data account in question was the wireless network data account related to that wireless device.

Monitoring software on a network device of the data network provider or elsewhere would maintain a monitoring loop at 7-1 to detect the existence of conditions in which it might be desirable to solicit the participation of a user of a user device in an advertising session in exchange for an earned credit to their data account. For example, in this case we explicitly assume the computer system is the wireless data network provider of the user, providing data service to the wireless device of the user being the user device.

There it might be desired to offer the user the ability to “earn” more data in their account by watching an advertisement. Determination of this condition by the wireless data network provider would equate to the detection of a trigger condition, shown at 7-2. Upon detection of the trigger condition, the network connected device of the wireless data network provider could issue a prompt to the user wireless device—see 7-3—inviting participation in an advertising session in exchange for a data credit or an earned credit of some other kind related to network service or network quality.

With a wireless device one primary way that the actual prompt could be issued to the user wireless device might be by something as simple as SMS text or other instant message including a link by which the user could if they did so activate the advertising session with the server. Decision block 7-4 demonstrates the point at which the user could either respond to the location or prompt by selecting to participate in an advertising session or not—if they elected to not participate in an advertising session continuation of the monitoring loop is shown.

If the user wished to participate in an advertising session in response to the prompt they could do so by activating the link or taking whatever other user intervention step had to do so. On election of the user to participate in an advertising session, a session request would be transmitted from the user wireless device to the advertising server—shown at step 7-5. Upon receipt of a valid session request, the advertising server in communication with the user device could initiate the advertising session which would comprise moving on to the identification step as shown.

It will be understood that the method in FIG. 7 is merely demonstrative of one high-level approach to initiating an advertising session under the remainder of the present invention. As outlined above and elsewhere herein, many approaches, of varying degrees of sophistication or automation, could initiate advertising sessions between a user device and the advertising server. It will also be understood obviously that the advertising server could facilitate multiple advertising sessions with multiple user devices at one time.

### Identification Step:

The identification step is the first step of the method within the conduct of an advertising session, once an advertising session is initiated. The primary element of the identification step of the method of the present invention is to provide the identification details of the target data account of the user to the advertising engine. As described elsewhere herein, the target data account of the user to which an earned credit is to be earned and applied might be a data account associated with the user device used to view the advertisement in the advertising session or could be a data account associated with another third-party device or otherwise.

There are several primary approaches which can be considered from the perspective of the identification step and how the identification particulars of the target data account could be gathered or provided by the user:
1. Where a locally installed client application was used on the user device, a locally installed client application could be pre-populated or could retain the details of the target data account for transmission to the server for association with an advertising session;
2. The user could be prompted via the user interface of the user device to manually enter the address or coordinates of the target data account—which might include identification of a data network provider, account number or otherwise;
3. Where the target data account was the network data account associated with the user device used to initiate or participate in the advertising session, the network coordinates or address of the user device can be captured and transmitted to the advertising server for use directly or to look up the identification coordinates of the target data account; or
4. In an embodiment of the advertising server that included a user profile database with profiles for users, the user could authenticate themselves to a user profile in that user profile database which was pre-populated with the identification coordinates have a target data account that that particular user like to use for applying earned data credits.

The advertising server, the advertising engine software component and the other related components of the system and method of the present invention can also be developed in a way that a hybrid approach could be used—providing multiple channels for the capture of identification details of target data accounts. For example, the server could automatically recognize user devices having a local have installed thereon and could communicate differently with those devices to identify the target data account then with other devices in which a manual interface was to be provided or still further devices in which automated capture of the network address or network coordinates of the user device could identify the target data account.

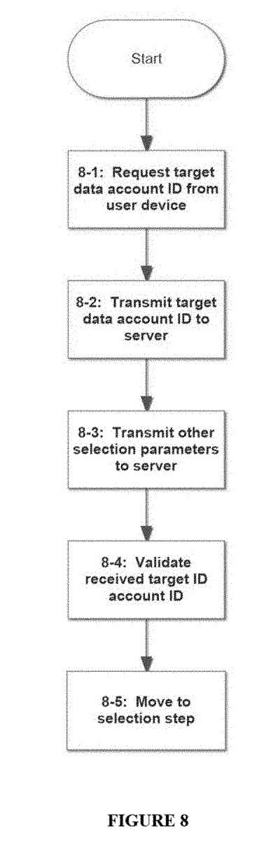

FIG. 8 is a flowchart demonstrating the steps in one embodiment of an identification step of the overarching method of the present invention. As outlined, the general concept of the identification step of the method is to obtain the identification details of the required target data account from the user of the user device, for use to issue an earned credit to that target data account upon completion of a requested or initiated advertising session. On initiation of the advertising session, following the initiation request to the server, the server would transmit a request for the target data account for vocation details to the user interface of a user device of the user having request of the advertising session. This is shown at 8-1.

In a response to the request for the identification details of the target data account, a user from that user device would transmit those target data account identification details to the server—as shown at step 8-2.

In certain embodiments of the method of the present invention such as that shown here, the user might also be asked or optionally enabled to provide additional selection parameters for transmission to the server—for example parameters which could be environmentally captured by the user device or manually entered by the user interface of the device to enhance the process of the selection of the selected advertisement record from the advertisement database. This might include for example GPS coordinates of the device, age of the user to ensure age of majority for advertisements which were only available context, or authentication to a user profile where user profile database existed on the advertising server 2 and contained further demographic profile information of the user which could further narrow or enhance the selection of the selected advertisement record for the administration of the remainder of this advertising session.

Following the transmission of the target data account identification details to the server, and optionally other selection parameters at step 8-3, some embodiments of the advertising engine software component 7 might validate the received target data account identification details to ensure that when an earned credit is to be applied following the completion of the advertising session that the appropriate information is in hand with which to do so. This is shown in this Figure at step 8-4. The validation step is obviously optional—capture of target data account identification details without validation is also intended to be within the scope of the present invention.

Following the capture of the target data account identification details and optionally other selection parameters, and later transmission of that information to the advertising server for the commencement of an advertising session, this subroutine of the overarching method would be completed, and the method could move on to the selection step, as shown at step 8-5.

### Selection Step:

The next step in the method of the present invention, following the identification step in which the identification details of the target data account would be captured, is the selection step in which a selected advertisement record is selected from advertisement records in the advertisement database. As outlined elsewhere herein, the selection step could comprise a random or cyclical selection from advertisement records in the advertisement database, or additional selection criteria related to the user, the user device, the data network provider or other parameters could narrow the selection of the selected advertisement record from a smaller subset of records within the advertisement database.

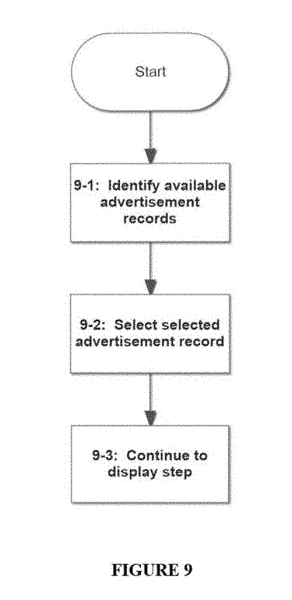

Referring to FIG. 9 there is shown a flowchart identifying three steps in a standard embodiment of this step of the method—shown at 9-1 is the initial selection of the subset of advertisement records from the advertisement database—either based on applying selection criteria or whatever other type of programming might be used within the advertising engine software component.

Based upon the isolation of a subset or set of advertisement records, a selected advertisement record could be selected at Step 9-2—either automatically or by offering a menu or an interface to the user via the user device from which they could select the desired advertisement record to be used in the advertising session. Following the selection of a selected advertisement record, the method could continue on to the display step.

### Display Step:

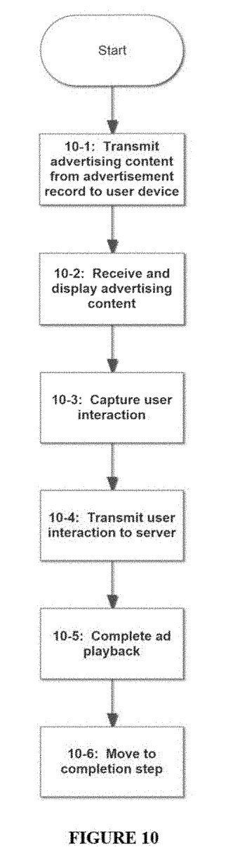

FIG. 10 shows the steps in one possible iteration of the display step of the method of the present invention. Following the selection of the selected advertisement record, the advertising content for the advertisement associated with that selected advertisement record will be transmitted to the user device for viewing by the user. This is shown at 10-1. As outlined elsewhere herein in certain cases, if the advertising content itself was stored within the advertisement database, the content could be streamed or transmitted directly from the server to the user device. In other cases, where the content for the advertisement was externally hosted or stored by the advertiser etc., the software on the server may in conjunction with software on the user device initiate a streaming session between the remote storage location for the content in the user device. Both such approaches will be within the scope of the present invention.

The user device will receive and display the advertising content—shown at 10-2.

In some cases, the advertisement itself might be made interactive or might gather additional demographic, identifying or other personal information from the user, to maximize the value of the advertising interaction for the advertiser. More compensation in an earned credit of higher value might be provided where interaction could be captured for transmission of provision to the advertiser. The capture of user interaction in certain cases—where an advertisement was interactive or allowed for the capture of user interaction—is shown in this Figure—at Step 10-3.

Following the capture of the user interaction with the advertisement in Step 10-3, the captured user interaction information would be transmitted back to the advertising server 2, shown at step 10-4. The playback of the advertisement is shown as complete at Step 10-5, moving on to the completion step of the method.

### Completion Step:

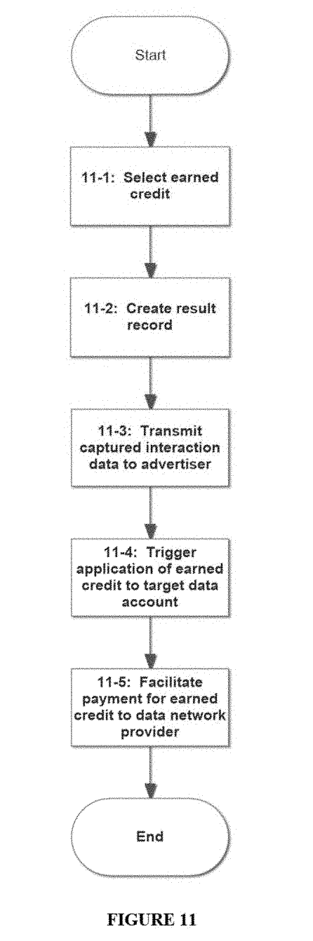

The final step is the completion step, which is shown in one embodiment in the flowchart of FIG. 11. Following the completion of the display of the advertisement related to the selected advertisement record, and the closure of the display step of the method, the first sub-step in the completion step is the selection of the earned credit to be awarded to the target data account of the user. The earned credit will be selected based upon the credit criteria stored in the selected advertisement record—sometimes only one type of an earned credit would be available from the advertiser regardless of other environmental parameters such as the data network provider particulars, user particulars etc., whereas in other cases, multiple types of earned credits might be offered or available. When multiple types of earned credits are permitted under the credit criteria stored in association with the selected advertisement record, the earned credit to be applied to the target data account can be automatically selected via the software on server, or in other cases a menu could be presented to the user via the interface of this user device and they can be allowed to select the credit they want to receive to their target data account. The full flexibility of the earned credits contemplated in network data accounts etc. are outlined in further detail elsewhere herein.

Following the selection of an earned credit to be applied to the target data account, in compensation or reward for having completed the advertising session, the next step would be the creation of a result record in the result database 6, shown at 11-2. The result record as shown and described elsewhere would include the details of the advertising session completed with the selected earned credit to be applied to the target data account in question.

With this Figure, additional information will have been received, with the display step in FIG. 10, from interaction of the user with the advertisement during its display. The captured interaction data from the user would be transmitted to the advertiser, shown at 11-3, and the advertising server 2 in operation or conjunction with the data network provider of the target data account would trigger the application of the earned credit to the target data account. As outlined elsewhere herein this could be done automatically or electronically, or could be done by the facilitation of a manual request for applying such a credit to the target data account.

Finally, in the embodiment shown, the final step at 11-5 is the facilitation of payment to the data network provider in compensation for the earned credit to be applied to the target data account outlined elsewhere herein could comprise payment directly from the operator of the advertising server, or the facilitation or creation of a commercial transaction directly between the data network provider and this advertiser. It will be understood this Figure only shows one most basic embodiment of a completion step under the remainder of the method of the present invention and there again can be many modifications, enhancements or alterations to the approach without departing from the intended scope of this application and the present invention.

Where payments to the data network providers are being facilitated these could either be done on the transaction by transaction basis as earned credits are issued, or a billing or aggregation framework can be established between the advertising method provider in the data network providers so periodic aggregated payments could be provided to simplify bookkeeping and payment processing. The specifics of the payment method are considered somewhat beyond the core scope of the present invention—any such approach is intended to be covered.

Many modifications to the steps in these subroutine flowcharts and substeps of the overarching method of the present invention will be understood to those skilled in the art, without departing from the overarching intention and direction here of and all such approaches again are contemplated within the scope of the present invention to the extent they do not depart from the overall intended method.

It will be apparent to those of skill in the art that by routine modification the present invention can be optimized for a wide range of conditions and application. It will also be obvious to those of skill in the art there are various ways and designs with which to produce the apparatus and methods of the present invention. The illustrated embodiments are therefore not intended to limit the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. In interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1. A method of advertising wherein a user is compensated by the application of an earned credit to a data account of the user in exchange for viewing an advertisement on a user device, said method comprising:
a. providing an advertising server operatively connected to a network, said advertising server comprising:
i. an advertising engine software component capable of facilitating the display of advertisements in advertising sessions to user devices on the network;
ii. an advertisement database containing at least one advertisement record corresponding to an advertisement of an advertiser for display to a user, each advertisement record comprising:
1. identification of the advertiser;
2. the necessary content for the advertising engine to facilitate the display of this advertisement to a user device connected to the network; and
3. credit criteria prescribing at least one type of earned credit which can be issued to the data account of a user for viewing the advertisement;
iii. a results database containing a result record corresponding to each completed advertising session, each result record comprising:
1. a link to the related advertisement record;
2. identification of the target data account of the user having completed the session; and
3. details of the earned credit to be awarded to the target data account;
b. on receipt by the server of an initiation request from a user device to initiate an advertising session, executing the steps of:
i. in an identification step, capturing and transmitting the identification details of a target data account of a user from the user device to the server;
ii. in a selection step, selecting a selected advertisement record from the advertisement database corresponding to a selected advertisement to be shown to the user;
iii. in a display step, displaying the content of the selected advertisement via the server on a user interface of the user device; and
iv. in a completion step, following the completion of the display of the selected advertisement on the user device:
1. selecting the earned credit to be awarded to the target data account based on the credit criteria associated with the selected advertisement record;
2. creating a result record in the results database storing the identification details of the target data account, details of the selected advertisement record corresponding to the advertising session, and the details of the earned credit to be provided to the target data account; and
3. causing the earned credit to be applied to the target data account.

2. The method of claim 1 wherein the advertisement record further comprises selection criteria which can be used in the selection step to narrow the available advertisement records for selection as the selected advertisement record.

3. The method of claim 1 wherein an advertising session is manually initiated by a user of a user device.

4. The method of claim 1 wherein an advertising session is initiated by the advertising engine in communication with a user device of a user on a network.

5. The method of claim 1 wherein an advertising session is initiated by a network device in communication with a user device of the user on a network.

6. The method of claim 1 wherein the selection step initially comprises the user transmitting selection criteria to the server for use by the advertising engine software component in selecting the selected advertisement record or available dataset from the advertisement database.

7. The method of claim 1 wherein the selection step comprises the user selecting a selected advertisement record via a user interface of the user device of the user.

8. The method of claim 1 wherein the selection step comprises the advertising engine selecting the selected advertisement record based upon details provided by the user.

9. The method of claim 1 wherein the earned credit provided to a target data account is selected from at least one of:
a. extending the capacity limit of the target data account by at least the network capacity required to view the advertisement;
b. crediting the capacity limit of the target data account by at least the network capacity required to view the advertisement;
c. not charging the capacity limit of the target data account by at least the network capacity required to view the advertisement;
d. enhancing the network speed provided to user devices using the target data account;
e. providing enhanced quality-of-service to user devices using the target data account;
f. providing access to exclusive network content to the user devices using the target data account;
g. goods or services of the data network provider of the target data account;
h. goods or services of the selected advertiser; or
i. goods or services of a third party.

10. The method of claim 9 wherein the user can select from multiple available earned credit options in the advertising session.

11. The method of claim 1 wherein the cost of the earned credit issued to a target data account is paid to the data network provider.

12. The method of claim 1 further comprising the step of periodically providing the details of result records from the results database to the corresponding advertisers.

13. The method of claim 1 wherein result records are anonymized before provision of the details thereof to corresponding advertisers.

14. The method of claim 1 wherein during an advertising session the user enters additional personal information via a user interface, and said additional personal information is stored to the corresponding result record.

15. The method of claim 14 wherein the value of the earned credit increases with the amount of additional personal information provided.

16. The method of claim 1 wherein the advertisement shown during an advertising session is interactive, and the user interacts with the advertisement via a user interface of the user device resulting in the capture of additional personal information, and said additional personal information is stored to the corresponding result record.

17. The method of claim 16 wherein the value of the earned credit increases with the amount of additional personal information captured.

18. The method of claim 1 wherein the number of users and target data accounts is more than one and the number of data network providers is more than one.

19. The method of claim 1 wherein the advertising server further comprises at least one network gateway by which the advertising server can communicate with at least one data network provider hosting the data accounts of users, to cause earned credits to be issued to the target data accounts of users.

20. The method of claim 19 wherein the number of data network providers is more than one and the advertising server and the at least one network gateway are configured to communicate with each data network provider.

21. The method of claim 1 wherein a user can initiate and participate in an advertising session from a user interface of a user device at any time.

22. The method of claim 1 wherein a user device software application is provided for installation on user devices, said application being used to initiate and participate in advertising sessions by a user.

23. The method of claim 1 wherein an advertising session is initiated by a prompt to the user of a user device triggered by a network device.

24. The method of claim 23 wherein the prompt comprises an electronic message to the user interface of the user device.

25. The method of claim 1 wherein the user device used to participate in an advertising session is a wireless device connected to a wireless network, and the target data account of the user is a wireless network account of the user device.

26. The method of claim 1 wherein the credit criteria regarding a particular advertising record are set by the advertiser.

27. The method of claim 1 the identification details of a target data account is the network address of the user device on the network of the data network provider by which said user device is in communication with the advertising server.

28. The method of claim 1 wherein the advertising server further comprises a user profile database containing at least one user profile record corresponding to a user and comprising:
a. identification particulars of the user; and
b. details of a target data account to which earned credits are to be credited;
wherein provision of the identification details of a target data account in the identification step comprises providing authentication of the user device to a user record.

29. The method of claim 30 wherein the user profile record also includes selection criteria pertaining to the user, which are used in the selection of selected advertisement records.

30. A method of advertising wherein a user is compensated by the award of a service credit to a target data account of the user in exchange for viewing an advertisement on a user device, said method comprising allowing a user, using a user device, to participate in an advertising session by, on initiation of the advertising session:
a. in an identification step, providing the identification details of a target data account of a user to an advertising engine software component on a server;
b. in a selection step, selecting a selected advertisement record corresponding to a selected advertisement to be shown to the user from an advertisement database on the server;
c. in a display step, displaying the selected advertisement on a user interface of the user device; and
d. in a completion step, following the completion of the display of the selected advertisement on the user device, using the server to select the earned credit to be awarded to the target data account based on credit criteria associated therewith; and
e. causing the earned credit to be applied to the target data account identified in the identification step.

31. The method of claim 30 wherein the advertisement record further comprises selection criteria which can be used in the selection step to narrow the available advertisement records for selection as the selected advertisement record.

32. The method of claim 30 wherein an advertising session is manually initiated by a user of a user device.

33. The method of claim 30 wherein an advertising session is initiated by the advertising engine in communication with a user device of a user on a network.

34. The method of claim 30 wherein advertising session is initiated by a network device in communication with the user device of the user on a network.

35. The method of claim 30 wherein the selection step comprises the user selecting the selected advertisement via a user interface of the user device of the user.

36. The method of claim 30 wherein the selection step comprises the advertising engine software component on the server selecting the selected advertisement record based upon the identification details of the target data account or other details of the user.

37. The method of claim 30 wherein the earned credit provided to the target data account is selected from at least one of:
a. extending the capacity limit of the target data account by at least the network capacity required to view the advertisement;
b. crediting the capacity limit of the target data account by at least the network capacity required to view the advertisement;
c. not charging the capacity limit of the target data account by at least the network capacity required to view the advertisement;
d. enhancing the network speed provided to user devices using the target data account;
e. providing enhanced quality-of-service to user devices using the target data account;
f. providing access to exclusive network content to the user devices using the target data account;
g. goods or services of the data network provider of the target data account;
h. goods or services of the selected advertiser; or
i. goods or services of a third party.

38. The method of claim 30 wherein the cost of the earned credit issued to a target data account is paid to the data account provider by the corresponding advertiser.

39. The method of claim 30 further comprising the step of periodically providing the details of completed advertising sessions to the corresponding advertisers.

40. The method of claim 30 wherein during an advertising session the user enters additional personal information via a user interface of the user device, wherein said additional personal information is stored for later provision to the corresponding advertiser.

41. The method of claim 40 wherein the value of the earned credit increases with the amount of additional personal information provided.

42. The method of claim 30 wherein the advertisement shown during an advertising session is interactive, and the user interacts with the advertisement via a user interface of the user device resulting in the capture of additional personal information, wherein said additional personal information is stored for later provision to the corresponding advertiser.

43. The method of claim 30 wherein the value of the earned credit increases with the amount of additional personal information captured.

44. The method of claim 30 wherein the number of data network providers is more than one.

45. The method of claim 30 wherein an advertising session is initiated by a prompt to the user of the user device triggered by a data network provider.

46. The method of claim 45 wherein the prompt comprises an electronic message to the user interface of the user device.

47. The method of claim 30 wherein the user device used to participate in an advertising session is a wireless device connected to a wireless network, and the target data account of the user is a wireless network account of the user device.

48. The method of claim 30 wherein the identification details of a target data account the network address of the user device on the network of the data network provider via which said user device is in communication with the advertising server.
